(19) United States
(12) Patent Application Publication
(10) Pub. No.: US 2005/0147757 A1
(43) Pub. Date: Jul. 7, 2005

(54) Method for wetting hydrophobic porous polymeric membranes to improve water flux without alcohol treatment

(76) Inventors: Il Juhn Roh, Carlsbad, CA (US); Craig Roger Bartels, San Diego, CA (US)

Correspondence Address: AKIN GUMP STRAUSS HAUER & FELD L.L.P., ONE COMMERCE SQUARE, 2005 MARKET STREET, SUITE 2200, PHILADELPHIA, PA, 19103-7013, US

(21) Appl. No.: 11/030,505

(22) Filed: Jan. 6, 2005

Related U.S. Application Data
(60) Provisional application No. 60/534,630, filed on Jan. 7, 2004.

(51) Int. Cl. B05D 3/02

(52) U.S. Cl. 427/372.2; 427/430.1

(57) ABSTRACT

A method is provided for substantially instantaneously wetting hydrophobic, porous polymeric membranes and for rendering hydrophobic membranes hydrophilic. The method involves treating the membrane with a non-alcoholic aqueous solution of a low molecular weight surfactant, and then drying the treated membrane. The low molecular weight surfactant exhibits high polymer affinity for the hydrophobic membrane substrate as well as high water solubility; a preferred surfactant is sodium dodecylbenzenesulfonate (SDBS). The method is particularly useful for treating hydrophobic membranes such as those made of polyolefins, fluorinated or chlorinated polymers, polysulfone, or polyethersulfone, preferably having a pore size of about 0.01 microns to about 1 micron. A wettable membrane is thus provided as the aqueous surfactant solution is absorbed into the hydrophobic membrane.

### CROSS-REFERENCE TO RELATED APPLICATION

This application claims the benefit of U.S. Provisional Patent Application No. 60/534,630, filed Jan. 7, 2004.

### BACKGROUND OF THE INVENTION

This invention relates to instantaneous wetting-out of dried, non-treated, virgin (not previously treated) hydrophobic, porous polymeric membranes and to rendering hydrophobic fibers water-wettable and hydrophilic without the use of alcohol treatment. The term “hydrophilic” is understood in the art to refer to materials (fibers) which do not repel water. “Water wettable” refers to fibers which are sufficiently hydrophilic that water will wick into the pores of the membrane at or near atmospheric pressure.

Many polymers which are used in commercially available, synthetic filtration membranes have inherently hydrophobic material properties. Among these hydrophobic polymers, polypropylene (PP), polyethylene (PE), polysulfone (PS), polyethersulfone (PES), and polyvinylidenefluoride (PVDF) are used extensively in membrane filtration applications because they are chemically stable and mechanically sturdy. Despite their extensive use in membrane applications, however, hydrophobic membranes are not wettable by water. Accordingly, for use in water-related filtration, the inherent hydrophobic material properties of a membrane should be changed to make the membrane hydrophilic, or pre-treatment should be carried out on the membrane to make it wettable by water. If the pores are not wetted, there will be no water flow through the pores and the membrane will be useless.

Methods for making hydrophobic membranes hydrophilic are well known in the art. Specifically, providing hydrophilic properties to hydrophobic membranes is generally performed by chemical and/or physical modifications by post-treatment processes. Chemical post-treatment processes typically involve chemical modification and/or grafting of hydrophilic chemicals onto pore surfaces by IR, UV, or cold plasma irradiation. In physical post-treatment modification processes, coating and/or curing of hydrophilic materials on the pore surfaces is typically preferred.

For example, U.S. Pat. Nos. 6,486,291; 6,274,701; 4,876,289; 5,049,275; 4,944,879; 4,618,533; and 5,084,173 disclose physical modifications of polyolefin membranes using curable, cross-linkable coating compositions. Further, U.S. Pat. Nos. 4,675,213; 4,663,227; 6,287,730; 6,093,559; 4,525,374; and 4,501,785 disclose hydrophilic membranes formed by coating a hydrophilizing agent on pore surfaces. These methods are, however, accompanied by one or more problems. For example, a coating of hydrophilic material which has been applied to pore surfaces by curing or polymerization dramatically reduces water flux through the membrane. Another difficulty of such methods is achieving uniform hydrophilicity throughout the thickness of the membrane. It has also been found that attempting to apply a hydrophilizing treatment uniformly over the entire thickness of a porous membrane by increasing the concentration of coating material is not effective because the water flux of the porous membrane decreases significantly. Finally, a disadvantage associated with coating methods is the poor durability of the coated materials on the surfaces of the pores. As a result of the physical modification, the coated materials dissolve out during the filtration process, which contaminates the permeated water.

An example of a chemical surface modification method is described in U.S. Pat. No. 5,209,849, in which a porous membrane is exposed to UV radiation while holding a hydrophilic photo-grafting monomer on the surface of the membrane. Further, U.S. Pat. No. 5,849,368 discloses a plasma treatment for rendering the hydrophobic surfaces of polymeric plastics hydrophilic. These types of processes are, however, also accompanied by one or more problems. For example, it is difficult to impart uniform hydrophilicity throughout the thickness of a membrane, regardless which method is used. Further, these types of treatments appear to render only the outer surface of the hydrophobic membrane hydrophilic, and the insides of the pores do not wet. Finally, attempting to uniformly apply a hydrophilizing treatment over the entire thickness of a thick porous membrane or a hollow fiber membrane results in unavoidable reduction of the mechanical strength of the matrix of the porous membrane, because the polymer molecule chain is broken during radiation treatment.

As previously explained, hydrophobic, porous, polymeric membranes which are to be used for water filtration may be made hydrophilic by wetting the surfaces of the membranes with a liquid having lower surface tension than the polymer. Conventionally used treating materials include low molecular weight alcohols, such as isopropanol (IPA) and ethanol, and solvents such as Freon® (chlorinated hydrocarbons).

Many surfactant-type chemicals have also been employed and have been successful to some degree in wetting hydrophobic, porous membranes. Commercially known chemical surfactants for hydrophobic membranes include Triton®, Tetronic®, Pluronic®, and Softanol®. These surfactants comprise ethylene oxide and/or propylene oxide copolymers with relatively high molecular weights.

Surfactants having high hydrophilic/lipophilic balance (HLB) exhibit good solubility in water so that even at room temperature, aqueous solutions are in a clean, homogeneous state. High water affinity and solubility can reduce rinsing time, so that low water consumption is used for washing the surfactant from the membrane after commencement of water filtration. However, high HLB surfactants do not have sufficient attraction for hydrophobic membrane materials. Accordingly, without the use of a low surface tension alcohol, this low affinity results in low diffusion of the surfactant solution into the porous structure of the hydrophobic membrane. Although dried hydrophobic membranes, after treatment with these surfactants, have been successful to some degree in water wetting, this low diffusion fails to provide instantaneous wet-out of dried and untreated hydrophobic membranes. Another problem associated with low affinity for the polymeric membrane is an unevenness of the coating, so that the surfactant either migrates to or accumulates in one section of the membrane material. While this one area is hydrophilic, other areas of the membrane continue to exhibit hydrophobic properties. As a result, these areas do not pass liquid and the desired flow rate is not achieved by the coated membrane. High HLB surfactants are thus not able to provide a total membrane “wet out”.

On the other hand, low HLB surfactants have a high attraction for hydrophobic materials but a low affinity for and solubility in water. These surfactants have a “cloud point” at room temperature at which an aqueous surfactant solution becomes cloudy, a change in appearance which seems to occur due to the formation of sols (gels) within the solution. Accordingly, elevated temperatures are needed to achieve a clean homogeneous solution of surfactant. To avoid solubility problems of low HLB surfactants in water, low molecular weight alcohols are often included in the solutions. However, these alcoholic solutions create many practical problems. For example, solution concentrations change continuously due to the evaporation of the alcohol, resulting in unpleasant odors, unhealthy working conditions, and high flammability. Another problem observed with low HLB surfactants is the difficulty of water passing through the membrane pores due to low hydrophilicity and rinsing from the membranes. As a result, it is difficult to achieve intrinsic water flux of the membrane. Further, during the water filtration process, the surfactant is continuously solved out into permeate water, thus contaminating the permeate water. Finally, the diffusion of aggregated surfactant chemicals into the microstructure of hydrophobic membranes is difficult, resulting in uneven coating of surfactant on the pore surfaces.

Among other problems with known surfactants is that many surfactants are neutral. In contrast, the most successful and widely used membrane materials for reverse osmosis (RO) have an anionic charge. As a result of this material property, RO membranes can be easily contaminated by surfactants and other materials having cationic or neutral properties, leading to significant water flux decline. To improve RO filtration performance and to reduce contamination of RO membranes during filtration, RO filtration systems include pre-filtration processes using porous membranes. However, when such porous membranes have been treated with surfactants, as described above, the treated membranes are difficult to use in pre-filtration processes for RO processing.

Finally, a number of surfactants, including those described above, may not directly “wet out” untreated hydrophobic membranes without the help of a low molecular weight alcohol. The diffusion of high HLB surfactants into hydrophobic membranes is not sufficient in itself for wetting, due to the low chemical affinity between the surfactants and hydrophobic membranes. On the other hand, low HLB surfactants having sufficient attraction for diffusion into hydrophobic membranes have low solubility in water. Because of these inherent solubility and affinity properties of many surfactants, the wet-out of untreated hydrophobic membrane by these surfactants cannot be successfully achieved.

Other chemicals having short hydrocarbon chains, such as sodium butyrate and sodium octanoate, have high water solubility but low affinity for hydrophobic materials, resulting in no wet-out of hydrophobic materials. The affinity for hydrophobic materials increases with the increase in hydrocarbon chain length. For example, sodium dodecyl sulfate (SDS) has been successful to some degree in wetting hydrophobic, porous membranes. However, increasing the hydrocarbon chain length also reduces the solubility of the chemical in water. Some hydroxyl compounds have good water solubility but low affinity for hydrophobic materials and high surface tension, resulting in no wet-out of hydrophobic, porous membranes.

Due to the disadvantages with known chemicals, there remains a need in the art for a chemical system which will effectively “wet out” fresh hydrophobic membranes directly, without the aid of an alcohol, and will provide hydrophilic properties to the hydrophobic membranes.

### BRIEF SUMMARY OF THE INVENTION

A method for treating a hydrophobic, porous polymeric membrane to render the membrane water wettable and hydrophilic is provided. The method comprises the steps of treating a dry hydrophobic membrane with a non-alcoholic aqueous solution of a low molecular weight surfactant and drying the treated membrane, such that after the drying, the hydrophobic membrane is rendered water wettable and hydrophilic with a substantially instantaneous water wet-out.

### DETAILED DESCRIPTION OF THE INVENTION

The present invention provides a method for treating hydrophobic, porous membranes to wet them and to provide water-wettable and hydrophilic properties without altering the inherent characteristics of the porous membranes, such as physical strength, chemical stability, resistance to radiation, etc. This method involves soaking and coating the substrate (membrane pores) with a chemical system containing a low molecular weight surfactant and water. It is been found that such a chemical system will substantially instantaneously (immediately) render hydrophobic membranes water-wettable and hydrophilic after completely drying the membranes—no aging or sitting is required. The method is applicable to virtually all known hydrophobic membranes.

The chemical system used in the method of the invention is attractive for several reasons. First, the low molecular weight surfactant has no volatility and is easy to rinse out of the membrane with water. Second, this chemical system provides substantially instantaneous wet-out of the dried, hydrophobic porous membrane without utilizing any other chemicals, such as low molecular weight alcohols.

As will be explained in more detail below, according to the invention, the fresh, hydrophobic membranes may be treated by dipping, soaking or immersing in a solution containing the surfactant and water. Simultaneously pressurizing the surfactant solution to the membrane is preferred to enhance the diffusion rate of the solution into the porous structure of the membrane. Alternatively, suction of the solution through or into the fibers or membrane also increases the diffusion rate of the solution into the porous structure of the membrane.

In all cases, the membrane is dried following surfactant treatment. After drying, the surfactant adsorbed on the surface of the hydrophobic porous membrane material and/or in the inner surface of the pores is retained evenly on these surfaces. Therefore, the dried membranes exhibit good initial water permeability so that wetting with other materials, such as alcohols, is not required.

The method according to the invention is attractive because hydrophilic, porous membranes can be prepared without complicated treatments and without lowering the inherent characteristics of the hydrophobic, porous membranes, such as physical strength, chemical stability and resistance to radiation. Because the solution used in the inventive method has an initial wetting ability, a solvent such as a low molecular weight alcohol is not required for initial wetting of the membrane as a first step in a hydrophilic treatment, as in conventional methods. Wetting a hydrophobic membrane and rendering the membrane hydrophilic can thus be performed simultaneously in a simple, one-step, straightforward and safe manner.

A wide variety of hydrophobic membranes may be treated by the method of the invention, including without limitation flat sheet, hollow fiber, or spiral wound membranes including membranes comprising polyethylene, polypropylene, polytetrafluoroethylene, polyvinylidene fluoride, polysulfone, polyethersulfone, and polyvinyl chloride, for example. While pore size of a membrane is not critical to the present invention, it is preferred that the pore size be about 0.01 to about 1 micron. It has been found that when the pore size of the membrane is too small, such as in reverse osmosis and low range pore size ultrafiltration membranes, initial wetting is difficult due to a low diffusion rate of the solution.

It is preferred that the low molecular weight surfactant be an anionic surfactant having a weight average molecular weight of less than about 1000 Daltons and greater than about 100 Daltons.

Preferred low molecular weight surfactants which are useful in the method of the present invention including sodium dodecyl sulfate (SDS) and sodium dodecylbenzenesulfonate (SDBS). SDBS is most preferred due to its good chemical affinity for and compatibility with hydrophobic materials. Further, it exhibits no cloud point at room temperature, requires small quantities for treatment, and has the ability to be easily rinsed out during a filtration process and to render hydrophobic materials water-wettable. Although SDBS has a long hydrocarbon chain and a sulfonate group, it exhibits high water solubility due to the aliphatic and aromatic hydrocarbon chains on the sulfonate group. Therefore, preparation of a relatively concentrated aqueous solution (e.g., 30% by weight) at room temperature is straightforward. Further, the high solubility of SDBS in water, even at room temperature in the absence of co-solvents, is also desirable for rinsing it from the membrane during water-filtration: SDBS can be rinsed from a membrane in a short time with a small quantity of water. Finally, only a low concentration of surfactant is needed for membrane treatment.

The long hydrocarbon chain of SDBS provides a good affinity for hydrophobic materials, such as polyethylene, polypropylene, partially fluorinated olefin polymers, polytetrafluoroethylene, polysulfone, and polyethersulfone. The hydrocarbon chain of SDBS solved in water interacts with the pore surfaces of the hydrophobic materials, resulting in diffusion of the SDBS water solution into the microstructure of the porous membrane and leading to wet-out of the dry, hydrophobic porous membrane. The porous, hydrophobic microstructure retains the surfactant in the membrane base material and the surfactant is substantially wholly and evenly coated over the hydrophobic polymer. Therefore, it has been found that using an SDBS treating solution, an even coating is provided throughout the micropores of the membrane, even for membranes in the sub-micron range (such as 0.01 micron), the smallest range evaluated. In all cases, no migration, aggregation, or clustering of SDBS to one section of the membrane has been detected.

The preferred chemical system for use in the method of the invention is a solution of SDBS and water, and may contain only these components in one embodiment. No additional diluent, such as an alcohol, is included in the solution. The concentration of SDBS needed to obtain good wettability and re-wettability is preferably about 0.5 to about 30 wt % based on the total weight of the solution. Even at such a relatively high concentration, the solution does not produce “cloud points” or a gel. Due to the high solubility of SDBS in water, the solution can be used in relatively small quantities, and a concentration as low as 0.5% may be effective. A more preferred concentration of SDBS is about 1 to about 10 weight %, since it has been found that lower concentrations can reduce bubble formation and the water consumption needed for rinsing. Concentrations higher than 30% increase the diffusion rate of the solution into the pores of the membrane, thus reducing wetting time. However, the time reduction by wetting at higher concentration is small, whereas the rinsing time of the chemical from the membrane after water filtration increases substantially. Conversely, the wetting time using a solution having less than about 1 wt % SDBS increases substantially, and a dried membrane treated with such a solution exhibits poor integrity of water wetting.

Following preparation of the aqueous surfactant solution for example at room temperature, the membrane is treated with the solution. In one embodiment, the microporous membrane of hydrophobic material is soaked, dipped, or immersed in the surfactant solution to allow the surfactant to migrate and impregnate into the membrane pores. The diffusion rate of the solution into the inner pores of the membrane may be accelerated by simultaneous high pressurizing (such as in a pressure vessel) or sucking of the solution into or through the porous membrane. Preferred pressures for pressurizing and sucking are about 0.5 to about 25 psi. These membrane treatments would be appropriate for hollow fiber, flat sheet, and spiral wound type porous membranes.

For example, by pressurizing a 2 weight % SDBS solution at 20 psi, a polypropylene hollow fiber membrane, having an average 0.2 micron diameter pore size, a 0.31 mm fiber outer-diameter and a 0.24 mm fiber inner-diameter, was wetted completely in 15 minutes at room temperature. For comparison, wetting the same membrane without pressurizing would require about 30 minutes to about one hour.

Elevating the temperature of the solution during or after preparation also accelerates the diffusion rate of surfactant into the porous structure, thereby reducing wetting time. For effectively wetting of a porous membrane with a low molecular weight surfactant, it is preferred that the solution temperature be higher than the critical point at which diffusion of diluents occurs, and lower than the temperature at which membrane integrity will be deleteriously affected. For example, the preferred temperature of a SDBS solution is about 0 to 100° C., more preferably about 20 to 80° C.

Following treatment of the membrane with the surfactant solution, the impregnated hydrophobic membrane is removed from the solution and hung to remove the excess solution on the surface of the membrane and inside the lumen of a hollow fiber membrane. Drying the wetted membrane containing the aqueous surfactant solution may be performed in air at room temperature for about 12 hours. Alternatively, an elevated temperature may be used to help dry the wetted membrane and to reduce the drying time. For drying efficiently, the air temperature should preferably be higher than room temperature and lower than the temperature at which membrane integrity is deleteriously affected. A preferred drying temperature is about 20 to 100° C., more preferably about 20° C. to about 60° C. The drying temperature does not affect the “wet-out” time (i.e., the time for the membrane to absorb water and begin to flow out water) or the rinsing time (i.e., the time for rinsing the surfactant out of the porous membrane during water filtration). In all cases, the dried membrane will “wet out” substantially instantaneously or immediately. After drying, the surfactant adsorbed by the surface of the porous membrane material and/or the inner surfaces of the pores is retained, yielding a hydrophilic porous membrane.

The dried membranes are preserved for end use and may be transported in a dry, water wettable, temporarily hydrophilic state in which the membranes are not susceptible to bacterial or mold growth. For utilization in a separation plant, for example, the dried membranes are immersed in water and suction is applied, causing water to pass through and into the pores. The membranes would now be suitable for water filtration. The presence of the surfactant thus allows the membranes to be wetted instantaneously for passing water through them. After wetting, however, the surfactant may be quickly rinsed out, such as with water, to prevent contamination of the permeate water with the surfactant. Once the surfactant has been removed, the membrane pores remain wetted. However, if the fibers are removed from water and allowed to remain in air, the pores will dry out and the fibers will return to a hydrophobic, non-wettable state, and will require a subsequent surfactant treatment to render them hydrophilic and water wettable once again.

A preferred manufacturing procedure for the wetting and coating involves preparing a surfactant solution by mixing 980 ml of deionized water and 20 g of SDBS at room temperature in a plastic container. This mixture is stirred gently for about ten minutes to insure uniform dispersion of the SDBS in water and to form a uniform and clear solution.

A bundle of hydrophobic polypropylene hollow fiber membranes containing 14,000 one-meter long fibers is then pressurized with the solution at 20 psi for ten to twenty minutes. The bundle wetted with the solution is then dried in air for one day or in an oven at 80° C. for 3 hours, and is then hydrophilic.

By pressurizing the dried hydrophilic membrane with water at 20 psi, the membrane bundle gains its intrinsic water flux in 5 minutes. The surfactant can also be rinsed out completely from the membrane material in 5 minutes. In other words, after 5 minutes the membrane bundle contains substantially no excess surfactant and produces a maximum water flux.

The invention will now be further illustrated by reference to the following specific, non-limiting examples.

### EXAMPLE 1

To evaluate the intrinsic water flux of a fresh polypropylene hollow fiber membrane, the membrane was “wet out” by dipping in a 50% by volume aqueous isopropanol solution for 10 minutes, followed by rinsing with deionized water for 5 minutes at one atmosphere. At equilibrium, the flow rate was observed at one atmosphere and room temperature to be 16.5 ml/min. This value was used for comparison with the water flux of the following membrane treated with surfactant chemical solution.

A clean solution of 10 weight % SDBS in water was prepared at room temperature. A small bundle of polypropylene hollow fibers having a pore size of 0.2 microns was then dipped in this SDBS solution at room temperature for 30 minutes. The bundle was removed from the solution and then rinsed with deionized water at one atmosphere pressure and room temperature for 5 minutes. After rinsing, the water flux was 16.0 milliliters per minute, compared with 16.5 ml/min for the membrane treated with IPA.

### EXAMPLE 2

The method described in Example 1 was repeated using different chemicals and concentrations in order to evaluate their effects on wetting of hydrophobic polypropylene porous membranes. The results are summarized in Table 1. It can be seen that the hydrophobic membranes were only wetted by 50% isopropanol and 20% sodium dodecyl sulfate (SDS). All of the other chemicals tested were not able to wet the membranes (i.e., no water flux was observed after dipping with the other chemical solutions). To measure the intrinsic water flux of the bundles, after soaking with isopropanol or SDS, the membranes were soaked again in 50% isopropanol.

TABLE 1
Solutions Used for Comparative Wetting Test

| | Concentration in | Water flux after soaking | Water flux after soaking |
|---|---|---|---|
| Chemicals | H₂O solution | membrane in solution | in 50% IPA |
| Isopropyl alcohol | 50 wt % | 20.5 ml/min | 20.5 ml/min |
| Glycerin | 50 wt % | No flux | — |
| Propylene glycol | 50 wt % | No flux | — |
| Hydroxyacetone | 50 wt % | No flux | — |
| Sodium butyrate | 20 wt % | No flux | — |
| Sodium octanoate | 20 wt % | No flux | — |
| Sodium dodecyl | 20 wt % | 24.0 ml/min | 25.2 ml/min |
| sulfate (SDS) | | | |
| Tetronic 908 | 10 wt % | No flux | — |
| Triton X-100 | 10 wt % | No flux | — |

### EXAMPLE 3

Clean chemical solutions having varying SDBS concentrations were prepared in water at room temperature. A bundle of polypropylene hollow fiber membrane containing 14,000 1-meter long fibers was pressurized with the surfactant solution at 20 psi for 15 minutes, and the flux rate was then measured at 15 psi at room temperature. Additionally, the intrinsic water flux of the membrane bundle was determined by dipping the treated bundle in a 50% by weight solution of isopropanol for ten minutes, rinsing with water for five minutes, and measuring at 15 psi. The results are shown in Table 2.

TABLE 2
Flux rate variation using different concentrations of SDBS

| Concentration of SDBS (wt %) | Flux (GPM) |
|---|---|
| 0.5 | 8.25 |
| 1.0 | 9.5 |
| 2.5 | 9.25 |
| 5.0 | 9.5 |
| 50% IPA | 9.5 |

It can be seen in Table 2 that the flux rate of the membrane bundle is lower when the concentration of SDBS is lower than 1%. The flux rate of membranes treated with concentrations of SDBS greater than 1 weight % is nearly identical to that treated with a 1 weight % solution, because the membrane bundle is already wetted fully in a 1 weight % SDBS solution. Therefore, while use of a higher concentration of SDBS could reduce wetting time, the time reduction is quite small.

### EXAMPLE 4

A clean solution of 2 weight % SDBS in water was prepared at room temperature. A bundle of polypropylene hollow fiber membrane containing 14,000 1-meter long fibers was pressurized with the surfactant solution at 20 psi for 15 minutes. The excess solution inside the lumens of the hollow fibers and on the surfaces of the membrane was removed by hanging the bundle for one hour in air at room temperature. The membrane bundle was then dried in air at room temperature for 1 day. The intrinsic water flux of the dried hydrophilic membrane was 9.5 gallons per minute (GPM) at 15 psig after pressurizing at 20 psi using water for 5 minutes.

### EXAMPLE 5

The method described in Example 4 was repeated using different concentrations of surfactant ranging from 0.5 to 5.0 weight %. The water permeability of each treated membrane was measured by determining the applied pressure needed to obtain the desired fixed flow rate of 3 gallons per minute (GPM), and the results are shown in Table 3.

TABLE 3
Effect of SDBS concentration on water flux of hydrophilic membranes

| Concentration of SDBS | | |
|---|---|---|
| (wt %) | Flow rate (GPM) | Pressure (psi) |
| 5.0 | 3 | 6.5 |
| 2.5 | 3 | 6.2 |
| 1.0 | 3 | 6.5 |
| 0.5 | 3 | 9.5 |

It can be seen from Table 3 that a membrane treated with a solution containing less than 1 weight % surfactant required a relatively high pressure (9.5 psi) for achieving the fixed flow rate. Further, hydrophilic membranes treated with solutions containing SDBS concentrations greater than or equal to 1 weight % required almost the same pressure (6.2-6.5 psi) to achieve the desired flow rate, regardless of the SDBS concentration.

### EXAMPLE 6

The method described in Example 4 was repeated. Since during water filtration, any chemicals used for hydrophilic treatment can cause problems by leaching out of the membrane, the time required to rinse the surfactant from the porous membrane was evaluated by the change in the water flux rate. The results are shown in Table 4.

TABLE 4
Rinsing time of surfactant at different water flux rates

Rinsing time (s)

| | | | |
|---|---|---|---|
| 2 | 4 | 5 | 8 |

| | |
|---|---|
| | Total Organic |
| Water flux rate | Carbon (TOC, ppm) |

| | | | | |
|---|---|---|---|---|
| 24 GFD | 11.0 | 4.8 | 0.4 | 0 |
| 36 GFD | 11.2 | 5.0 | 0.3 | 0 |

It can be seen that substantially all of the surfactant absorbed on the porous hydrophobic membrane dissolves out of the membrane in about 5 minutes regardless of the water flux rate. It appears that dissolving surfactant out of the membrane depends upon the diffusion rate of the surfactant into water.

It can be seen that the method according to the invention is attractive for providing hydrophilic properties and substantially instantaneous wet-out to hydrophobic membranes. The use of a low molecular weight surfactant in water according to the invention does not require pre-wetting of the membrane or the use of a co-solvent, thus providing a one-step process without the need for additional materials.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

1. A method for treating a hydrophobic, porous polymeric membrane to render the membrane water wettable and hydrophilic, comprising the steps of treating a dry hydrophobic membrane with a non-alcoholic aqueous solution of a low molecular weight surfactant and drying the treated membrane, such that after the drying, the hydrophobic membrane is rendered water wettable and hydrophilic with a substantially instantaneous water wet-out.

2. The method according to claim 1, wherein the hydrophobic, porous polymeric membrane comprises a polymer selected from the group consisting of polypropylene, polyethylene, polytetrafluoroethylene, polyvinylidene fluoride, polysulfone, polyethersulfone, and polyvinylchloride.

3. The method according to claim 1, wherein the low molecular weight surfactant is at least one selected from the group consisting of sodium dodecyl sulfonate and sodium dodecylbenzenesulfonate.

4. The method according to claim 1, wherein the low molecular weight surfactant comprises an anionic surfactant.

5. The method according to claim 1, wherein the low molecular weight surfactant has a weight average molecular weight less than about 1000 Daltons.

6. The method according to claim 1, wherein the aqueous solution has a surfactant concentration of about 0.5 to about 30 weight % based on a total weight of the solution.

7. The method according to claim 6, wherein the surfactant concentration is about 1 to about 10 weight % based on a total weight of the solution.

8. The method according to claim 1, further comprising heating air to about 20° C. to about 100° C. and drying the treated membrane by moving the heated air over the treated membrane.

9. The method according to claim 1, wherein the treating comprises at least one selected from the group consisting of soaking, dipping, and immersing the membrane in the solution.

10. The method according to claim 9, wherein the treating comprises heating the solution to about 20° C. to about 80° C. and soaking, dipping, or immersing the membrane in the heated solution.

11. The method according to claim 9, wherein the treating comprises sucking or pressurizing the solution to about 0.5 to about 25 psi and soaking, dipping, or immersing the membrane in the treated solution.

12. The method according to claim 10, wherein the treating comprises sucking or pressurizing the solution to about 0.5 to about 25 psi and soaking, dipping, or immersing the membrane in the treated solution.

13. The method according to claim 1, wherein a pore size of the membrane is about 0.01 microns to about 1 micron.

14. The method according to claim 1, wherein the membrane is in a hollow fiber form.

15. The method according to claim 1, wherein the membrane is in a flat sheet form.

16. The method according to claim 1, wherein the membrane is in a spiral wound form.
